(19) United States
(12) Patent Application Publication
(10) Pub. No.: US 2021/0004077 A1
(43) Pub. Date: Jan. 7, 2021

(54) APPARATUS FOR PRESENTING A VIRTUAL REALITY SIMULATION, AND LEISURE FACILITY HAVING SUCH AN APPARATUS

(71) Applicant: VR COASTER GMBH & CO. KG, Kaiserslautern (DE)

(72) Inventor: Dennis GORDT, Sexau (DE)

(21) Appl. No.: 16/969,449

(22) PCT Filed: Nov. 6, 2018
(86) PCT No.: PCT/EP2018/080356

§ 371 Date: Aug. 12, 2020

(30) Foreign Application Priority Data
Feb. 14, 2018 (EP) 18156660.5

(51) Int. Cl. G06F 3/01; G05D 1/00; G05D 1/12; G06T 19/00

(52) U.S. Cl. CPC G06F 3/011; G05D 1/0022; G06T 19/006; G05D 1/0094; G06T 19/003; G05D 1/12

(57) ABSTRACT

The present invention relates to an apparatus (2) for presenting a virtual reality simulation, comprising at least one data processing system (20) by means of which the virtual reality simulation is generated, at least one VR display device (22) by means of which the virtual reality simulation generated by the at least one data processing system (20) is presented, and at least one data link (21) connecting the data processing system (20) and the VR display device (22), wherein a tracking means (4) is provided, and wherein the at least one data processing system (20) follows the at least one VR display device (22) by means of the tracking means (4).

The present invention relates to an apparatus for presenting a virtual reality simulation and a ride having such an apparatus that enables a special experience in a VR world of experience, with the help of which a particularly high degree of immersion is achieved.

Various designs of apparatuses of this type are known from prior art. Generating complex virtual reality simulations requires a large amount of computing power from so-called data processing systems which generate the virtual reality simulations. The data processing systems not only generate the virtual reality simulation that is presented on a VR display device, but also collect a large amount of information that is taken into account when generating the virtual reality simulation. This information relates to the movements of the user and to objects located in the area of the user, and is reproduced in the VR world displayed to the user. Such objects should in particular increase the experience and excitement of the experience, and stimulate further sensory stimuli in addition to visually stimulating the user. Interaction with moving objects in particular requires particularly high computing power.

In prior art, the use of so-called “backpack PCs” has proven itself. Backpack PCs are modeled on conventional backpacks and include a power supply or a battery and a data processing system that generates a virtual reality simulation. The VR display device is connected to the data processing system by means of a wired data link.

Backpack PCs of this type allow the user to move freely, but both the computing power and the energy supply carried by the voltage source are limited, which on the one hand limits the VR experience in terms of time and on the other hand limits the display quality and the richness of detail of the virtual reality simulation. In addition, such apparatuses place an extraordinary weight load on the user, so that the user feels impaired by the weight despite the increased freedom of movement and is restricted in his freedom of movement.

It is therefore the problem of the present invention to provide an apparatus of the type mentioned above, which enables the user to experience a virtual reality simulation that is as detailed and complex as possible with a particularly high degree of immersion. In addition, the duration of use should not be subject to any restrictions and the apparatus should be suitable for the continuous operation of a ride during ongoing day-to-day operation. The user should have the greatest possible freedom of movement, be placed under little or no weight load and be able to interact with objects or other users, which means that the experience in the VR world is not limited to audiovisual stimuli.

This problem is solved according to the invention by the apparatus with the features of claim 1 and the ride with the features of claim 9. The dependent claims contain advantageous further developments of the invention.

The apparatus according to the invention for presenting a virtual reality simulation with the features of claim 1 comprises at least one data processing system by means of which the virtual reality simulation is generated, at least one VR display device by means of which the virtual reality simulation generated by the at least one data processing system is presented, and a data link connecting the data processing system and the VR display device. In addition, at least one tracking means is provided, which transports the at least one data processing system, so that the data processing system follows the VR display device. The data processing system is conveyed not by the user, but by the tracking means, so that the data processing position is not subject to any restrictions in terms of size and weight. Furthermore, the energy supply carried is not limited to the size of a battery that can be carried by humans. The apparatus is therefore particularly suitable for use in a ride with continuous daily operation. The tracking means follows the VR display device or the user, which means that the data link between the VR display device and the data processing system only has to bridge short distances, as a result of which both the data transmission and the business operations are less susceptible to faults. The tracking means is therefore designed such that it has means for accommodating the data processing system and that the data processing system can be conveyed by the tracking means.

In addition, it is particularly advantageous if the data link between the data processing system and the VR display device is a wireless connection or if the data link between the data link system and the VR display device is a wired connection. In particular, the wireless connection between the data processing system and the VR display device has the advantage that the user is completely free to move. The VR content can particularly preferably be streamed using the data link. The tracking means should be arranged in such a way that the distance between the data processing system and the VR display device is reduced to a minimum, which means that less radio power is required. Wired data links can be designed in such a way that relative movements between the VR display device and data processing are elastically absorbed, so that the user does not feel restricted in his freedom of movement even with a wired data link between the VR display device and the data processing system.

According to a further advantageous embodiment of the present invention, the tracking means comprises a vehicle, in particular a rail vehicle, a land vehicle or an aircraft. Land vehicles are understood to mean all types of wheel- or chain-operated vehicles, mixed forms also being possible. In particular, aircraft drones in the form of a multicopter are preferred as an aircraft, or aircraft that work in whole or in part according to the Archimedes principle. The invention described here is not limited to the vehicles mentioned above, but all apparatuses that are suitable for accommodating data processing systems and that can form a tracking means are also conceivable.

The vehicle thus transports the data processing system and follows the user. The vehicle can easily transport larger loads and the size and weight of the data processing system and the energy source are not subject to any user-specific restrictions. The vehicle can follow the user regardless of location, thereby achieving maximum freedom of movement for the user. The apparatus can be used both indoors and outdoors.

It is particularly advantageous if the vehicle is an autonomously driving vehicle and uses a sensor system to follow the VR display device or the user. The sensor system can comprise at least one camera, GPS, indoor tracking means, radar and/or radio. In particular, so-called low-energy sensor modules are preferred, as a result of which the energy supply of the voltage source is preserved as long as possible.

The camera can optically track the user. A distance measurement to detect the distance between the user and the vehicle can be carried out by a 3D camera or suitable sensors. The vehicle can also follow the user using GPS or indoor tracking.

The sensor system consequently detects the movement of the VR display device or the user and ensures that the distance between the data processing system and the VR display device or the user does not exceed a tolerated level.

Furthermore, it is advantageous if the tracking means includes at least one rail guide and the vehicle, wherein the data processing system is guided along the rail guide by means of the vehicle. Rail guides are generally known for enabling the smoothest possible movement between the vehicle and the rail guide, as a result of which the frictional resistance when tracking the data processing system is reduced to a minimum. This is particularly advantageous in the case of a wired connection between the data processing system and the VR display device, as the user can simply pull the vehicle behind him Because of this ease of movement, the user does not feel restricted or thereby hindered in his freedom of movement. In particular the user does not notice the pulling of the data processing system due to the high degree of immersion.

According to a further embodiment of the present invention it is particularly advantageous if the tracking means has a power supply. The data processing system and the VR display device—in the case of a wired connection between the VR display device and the data processing system—are thus supplied with electrical energy by means of the power supply for the tracking means. The use of the apparatus is therefore not limited in time and the data processing system does not have to be optimized with regard to energy efficiency. There are therefore no limits to performance and graphic detail. The power supply can be implemented, for example, by means of a live rail, which is part of the rail guide or runs at a distance from it. Alternatively, the power supply can be an electrically conductive grid which is arranged above the user in the room. The tracking means or the vehicle of the tracking means typically comprises a current collector that establishes an electrical connection with the power supply.

Furthermore, it is also particularly advantageous if the rail guide or the vehicle has a drive, as a result of which the vehicle of the rail guide independently follows the VR display device or the user together with the data processing system.

It is also particularly advantageous if the tracking means, in particular the rail guide, circumscribes a closed circulating path. The vehicle can travel the tracking means an unlimited number of times without changing direction, without requiring any intervention by the user or another person.

Furthermore, the present invention relates to a leisure facility having at least one apparatus according to the invention. The leisure facility can enable a large number of users to experience a virtual reality simulation at the same time.

According to an advantageous embodiment of the invention, several data processing systems of the apparatus can communicate with one another, so that the different users can also interact. The users can either experience the same virtual reality simulation or a different virtual reality simulation that corresponds to the personal preferences of the particular user. The data processing systems exchange both their position and the position of the user and prevent uncontrolled collisions.

Furthermore, it is advantageous if the leisure facility has an experience path that follows a circulating path. The experience path specifies the path by which the user can walk through the leisure facility using physical means or a corresponding representation in the VR world, wherein the physical means can be integrated into what is happening in the VR world. The freedom of movement of the user is artificially restricted by the experience path, so that tracking the data processing system by means of the tracking means can be carried out particularly easily due to the predefined space in which the user can move. In addition, the user is restricted in his freedom of discovery by the predetermined experience path and is required to move quickly through the course, so that a pass rate required for the leisure facility is ensured for an economical operation of the ride.

According to a further preferred embodiment of the invention, the course of the experience path and the course of the tracking means, in particular the rail guide, correlate with one another. The course of the tracking means either corresponds exactly to the course of the experience path or deviates slightly therefrom. The courses of the experience path and the tracking means therefore substantially match, wherein the tracking means can be used specifically to limit the freedom of movement beyond the experience path for the user.

The entry to and the exit from the experience path are preferably arranged adjacent to one another, so that the apparatus according to the invention can be reused for a new user as quickly as possible after use. For reasons of hygiene, the VR display device can be arranged interchangeably on the apparatus, so that appropriate cleaning can be carried out after each use without there being any delay in the process. The experience path can follow a wide variety of routes, have gradients, slopes and extend over several floors. It is particularly advantageous if the entry and exit are arranged at a local minimum, or even at an absolute minimum of the experience path in relation to the height profile, so that the tracking means does not have to generate braking or holding forces when entering and exiting.

In addition, it is particularly advantageous if the ride is an indoor facility or indoor ride, as a result of which the components of the ride are protected against the ingress of rain and moisture.

A preferred embodiment example of the invention is described in detail below with reference to the accompanying drawings. In the drawings:

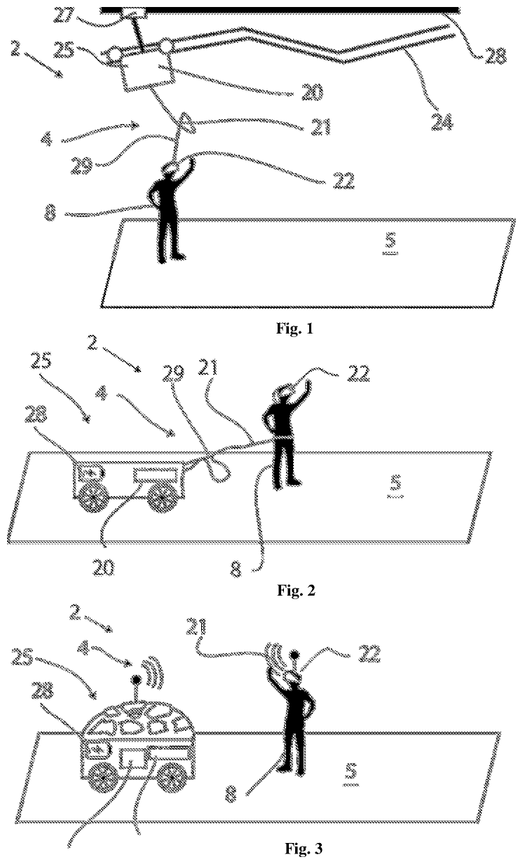

FIG. 1 shows a first embodiment example of an apparatus according to the invention with a tracking means with a rail guide arranged above the user,

FIG. 2 shows a second embodiment example of an apparatus according to the invention with a land vehicle that transports a data processing system, a wired data link connecting the data processing system to a VR display device,

FIG. 3 shows a third embodiment example of the apparatus according to the invention according to FIG. 2, a wireless data link transmitting the VR content from the data processing system to the VR display device and the land vehicle following the user completely autonomously,

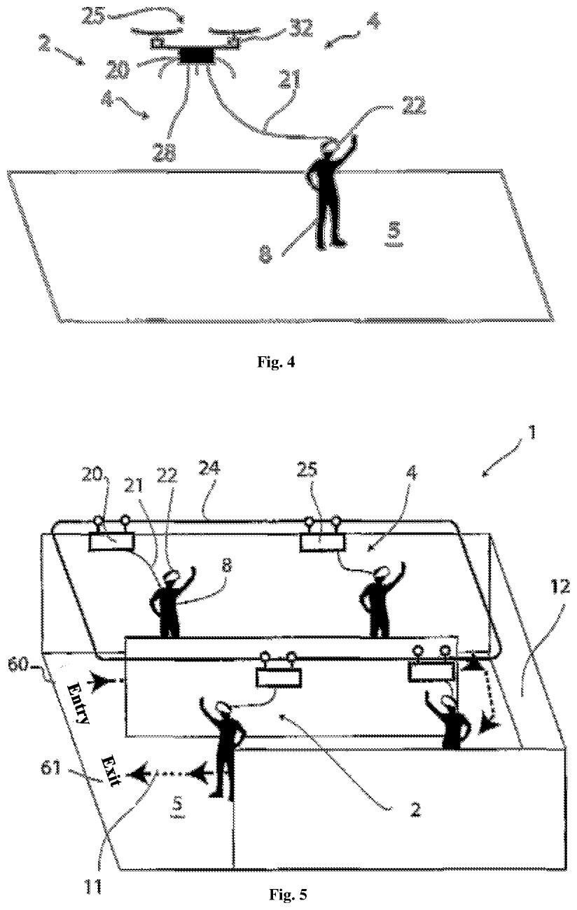

FIG. 4 shows a fourth embodiment example of the apparatus according to the invention, tracking being implemented by means of an aerial drone, and

FIG. 5 shows a ride with an apparatus according to the invention according to FIG. 1.

An apparatus 2 according to four preferred embodiment examples of the invention is described in detail below with reference to FIGS. 1 to 4. FIG. 5 relates to a preferred embodiment example of a ride 1.

The apparatus 2, illustrated in FIG. 1, comprises a data processing system 20 that generates a virtual reality simulation, a VR display device 22, a data link 21 and a tracking means 4. The tracking means 4 comprises the data processing system 20.

A user 8 wears the VR display device 22, which is designed in the manner of a head-mounted display, in front of his eyes. The image of the optical reality in the current field of view of the user is replaced, by the head-mounted display, with the stereoscopic representation of a virtual reality which is generated by the data processing system 20, and is transmitted to the VR display device 22 by means of the data link 21. The representation of virtual reality or of the VR content takes place depending on the position and/or orientation of the head-mounted display in synchronism with the head movement of the user 8 and is adapted in real time. Optical reality can also be recorded by a camera and expanded in the representation of the head-mounted display by importing augmented reality effects.

The VR display device 22 is connected to the data processing system 20 by means of the wired data link 21. The data processing system 20 is preferably a computer with particularly high computing power, as a result of which a very high graphic quality of the VR content shown by the VR display device 22 is achieved.

When experiencing the VR world, the user 8 can move in a room 5, the relative movements between the user 8 and the data processing system 20 being made possible by the length of the wired data link 21 and by the tracking means 4.

The tracking means 4 comprises a rail guide 24, on which a vehicle 25 in the form of a carriage or wagon is movably arranged and on which the data processing system 20 is arranged. The rail guide 24, the vehicle 25 and the data processing system 20 are arranged above the user 8 in the room 5, so that the tracking means 4 and the data processing system 20 do not stand in the way of the user 8 when he moves in the room 5.

Tracking the vehicle 25 or the data processing system 20 in the present example takes place by means of a wire rope 29, which at the same time serves as a guide for the wired data link 21. The wire rope 29 or the wired data link 21 can be held in tension by means of a spring pulley, whereby sudden movements of the user 8 can be resiliently absorbed in order to allow the user 8 the greatest possible freedom of movement when moving through the room 5.

In addition, the tracking means 4 comprises a power supply 28 which supplies the data processing system 20 and the VR display device 22 with electrical energy. The power supply 28 can be integrated in the rail guide 24, for example by means of at least one additional power rail. A current collector 27 on the vehicle 25 picks up the electrical current from the power supply 28 and thus supplies the data processing system 20 that moves with the vehicle 25.

FIG. 2 shows a second embodiment example of the apparatus 2. The tracking means 4 comprises the vehicle 25 or a land vehicle which is pulled by the user 8 with the aid of a wire rope 29 and/or a tow bar. The land vehicle 25 transports the data processing system 20 and a power supply 28 which supplies the data processing system 20 with electrical energy. In the present case, the power supply 28 is a rechargeable battery, which can be recharged by a suitable charging station in the ride 1. The charging stations can preferably be wireless charging stations.

The wire rope 29 or the tow bar for pulling the vehicle 25 are for example fastened to the user 8 by means of a belt 23.

Another embodiment example can be seen in FIG. 3, which, by analogy with the embodiment example according to FIG. 2, includes a vehicle 25 which transports the data processing system 20. In this embodiment example the tracking means 4 is however not physically coupled to the user 8, but is designed as an autonomously driving vehicle 25, as a result of which the user 8 feels completely free and can move unhindered.

The vehicle 25 follows the user 8 by means of an intelligent controller and a sensor system. The sensor system comprises visual tracking by means of at least one camera, a distance meter which records the distance to the user, GPS or indoor tracking means for indoor applications via Bluetooth or WLAN or the like. The vehicle 25 follows the user 8 at a predetermined but arbitrarily adjustable distance, for example 2m, and always tries to stay behind him in the direction of movement of the user 8.

In addition to a power supply 28 and the data processing system 20, the autonomously driving vehicle 25 comprises drives 32 by which the autonomously driving vehicle 25 is driven and steered. The power supply 28 is a rechargeable battery that can be charged wirelessly or inductively or conventionally by means of plugs at the designated positions in the ride.

Alternatively, the power supply 28 can be designed as an electrically conductive grid that is arranged in the room 5 above the user 8. A current collector 27 on the vehicle 25 establishes an electrical connection with the electrically conductive grid, as a result of which the vehicle 25 is supplied with electrical energy.

The data processing system 20 is connected to the VR display device 22 by means of a wireless radio connection, the VR content being streamed, i.e. in real time, by means of the radio connection, for example. In addition, the data processing system 20 detects the position relative to the user 8, on the one hand, in order to recognize whether the user is moving away from the autonomously driving vehicle 25, in order to follow the latter by means of a corresponding feed motion by the drives 32. On the other hand, the autonomously driving vehicle 25 is displayed true to position in the VR world, as a result of which the user 8 is shown this by the VR display device 22 and thus does not run the risk of tripping over the autonomously driving vehicle 25. The autonomously driving vehicle 25 can for example be represented in the VR world or the VR display device 22 as an animal—here a turtle—following the user 8, wherein the vehicle 25 can have a corresponding surface that is modeled on the animal, so that it can also create a tactile experience.

The data processing system 20 of a user 8 can share its position with the data processing system 20 of other users 8 and vice versa. Thus, multiple users 8 can use an apparatus 2 according to the invention in a room 5 without running the risk of colliding with one another.

According to FIG. 4 the tracking means 4 can also consist of an aircraft 25 which transports the data processing system and the power supply 28 for the data processing system 20. In the present embodiment example, the vehicle 25 is a multicopter, and the data can be transmitted between the data processing system 20 and the VR display device 22 analogously to the data links 21 shown in FIGS. 2 and 3.

Analogous to the autonomously driving land vehicle 25, the aircraft 25 is equipped with a sensor system by means of which the aircraft 25 can follow the user 8.

FIG. 5 shows a greatly simplified and schematically illustrated leisure facility 1 having an apparatus 2 according to the invention.

The leisure facility 1 has a circulating experience path 11 along which the users 8 can walk. The tracking means 4, which is designed as a rail guide 24, is provided above the user 8 in the room 5 with the experience path 11. The course of the tracking means 4 follows the experience path 11, so that the course of the tracking means 4 corresponds to the course of the experience path 11. Users 8 enter the leisure facility 1 through an entrance area 60. In the entrance area 60 users 8 can select their individual virtual reality simulation and are presented with a VR display device 22 which is connected by means of the wired data link 21 to the data processing system 20 guided on the rail guide 24 and presents the VR world to them.

Each user 8 can then follow the experience path 11, wherein the course of the experience path 11 correlates with the course of the rail guide 24. The experience path 11 is laterally delimited by objects 12 keeping the user 8 on the course. In addition, objects 12 are displayed in the VR world, so that the user 8 does not run the risk of colliding with the objects 12 in an uncontrolled manner.

The data processing system 20 carried on the rail guide 24 by means of a vehicle 25 can be tracked by means of the sensor system and the drive 32, the sensor system for example detecting a pull on the wired data link 21 or the distance to the user 8 or the VR display device 22. The motorized tracking means 4 of the vehicle 25 along the rail guide 24 prevents the wired data link 21 from being under tension and the user 8 having the feeling that his freedom of movement is restricted.

The user 8 travels along the experience path 11 and, after the VR experience has ended, leaves the leisure facility 1 through the exit area 61. The exit area 61 lies along the circulating rail guide 24 directly next to the entrance area, so that the apparatus 2 for presenting the virtual reality simulation is immediately available for a new user 8. For hygiene reasons, the VR display device 22 can be replaced or cleaned between the exit area 61 and in the entrance area 60. Such an arrangement is particularly suitable for rides 1 aimed at a high throughput of users.

Charging stations for the batteries of the VR display device 22 or of the vehicles 25 can be arranged in the exit area 61 or in the entrance area 60. Since the vehicles 25 and the VR display device 22 remain in one position for a long time in this area, they can preferably be charged wirelessly according to the induction principle.

Thus, according to the invention, an apparatus 2 for presenting a virtual reality simulation and a ride 1 having such an apparatus 2 can be made available, which make it possible to experience a highly detailed virtual reality simulation by means of which a particularly high degree of immersion or even presence can be generated. The apparatus 2 makes it possible to carry a particularly powerful data processing system 20. The physical bodily strain on the user 8 is reduced to the lowest possible level, as a result of which the apparatus 2 can be used regardless of anatomy, both by adults and by children.

### LIST OF REFERENCE NUMERALS

1 Leisure facility
2 Apparatus
4 Tracking means
5 Room
8 User
11 Experience path
20 Data processing system
21 Data link
22 VR display device
24 Rail guide
25 Vehicle
27 Current collector
28 Power supply
29 Rope
32 Drive
60 Entrance area
61 Exit area

1. Apparatus (2) for presenting a virtual reality simulation, comprising:
at least one data processing system (20), by means of which the virtual reality simulation is generated,
at least one VR display device (22), by means of which the virtual reality simu-lation generated by the at least one data processing system (20) is presented,
at least one data link (21) connecting the at least one data processing system (20) and the VR display device (22),
characterized in that
at least one tracking means (4) is provided and in that the at least one data pro-cessing system (20) follows the at least one VR display device (22) by means of the at least one tracking means (4).

2. The apparatus (2) according to claim 1, characterized in that the data link (21) be-tween the data processing system (20) and the VR display device (22) is a wireless connection, or in that the data link is a wired connection.

3. The apparatus (2) according to claim 1, characterized in that the tracking means (4) comprises a vehicle (25), in particular a rail vehicle, a land vehicle or an aircraft.

4. The apparatus according to claim 3, characterized in that the vehicle (25) is an autonomously driving vehicle (25) and comprises at least one drive (32) and a sensor system, and in that the vehicle (25) follows the VR display device (22) or the user (8) at a distance.

5. The apparatus according to claim 4, characterized in that the sensor system comprises at least one camera, GPS, indoor tracking means, distance sensor, radar and/or radio location.

6. The apparatus (2) according to claim 3, characterized in that the tracking means (4) has at least one rail guide (24), on which the vehicle (25) is guided and held.

7. The apparatus (2) according to claim 1, characterized in that the tracking means (4) comprises a power supply (28).

8. The apparatus (2) according to claim 1, characterized in that the tracking means (4) forms a closed path.

9. A leisure facility (1) having an apparatus (2) according to claim 1.

10. The leisure facility (1) according to claim 9, characterized in that several data processing systems (20) can communicate with one another.

11. The leisure facility (1) according to claim 9, characterized in that the leisure facility (1) is an indoor ride.

12. The leisure facility (1) according to claim 9, characterized in that an experience path (11) is provided which follows a circulating path.

13. The leisure facility (1) according to claim 12, characterized in that the course of the experience path (11) correlates with the course of the tracking means (4).

14. The leisure facility (1) according to claim 9, characterized in that the tracking means (4) is arranged above, next to, or below the user (8).
